(19) United States
(12) Patent Application Publication
(10) Pub. No.: US 2021/0127051 A1
(43) Pub. Date: Apr. 29, 2021

(54) CAMERA FUSION AND ILLUMINATION FOR AN IN-CABIN MONITORING SYSTEM OF A VEHICLE

(71) Applicant: BYTON NORTH AMERICA CORPORATION, Santa Clara, CA (US)

(72) Inventors: Zhenhua Lai, Fremont, CA (US); Albert Au, San Jose, CA (US)

(21) Appl. No.: 16/666,368

(22) Filed: Oct. 28, 2019

(51) Int. Cl. H04N 5/235; H04N 7/18; H04N 5/225

(52) U.S. Cl. CPC H04N 5/2354; H04N 5/2355; B60R 11/04; H04N 5/2258; H04N 7/18

(57) ABSTRACT

A vehicle in-cabin monitoring system is disclosed. For one embodiment, the system includes a sensor module, the sensor module includes a plurality of image sensors (e.g., cameras). The system includes a first illumination source. The system includes a signal generator to generate a sync signal to sync a first and a second of the plurality of image sensors to monitor an interior cabin of a vehicle, where the sync signal is to synchronize the first illumination source to the first image sensor such that objects illuminated by the first illumination source is not captured by the second image sensor while allowing the first image sensor to capture objects illuminated by the first illumination source. For another embodiment, one or more captured images are fused together.

### FIELD

The disclosed embodiments relate generally to vehicle systems and in particular to camera fusion and illumination for an in-cabin monitoring system of a vehicle.

### BACKGROUND

A traditional driver monitoring system (DMS) only tracks the driver using infrared sensors to monitor driver attentiveness. Specifically, the DMS places a camera in front of the driver along with some infrared (IR) LEDs (as an illumination source) to track driver head position and eye movement for daytime/nighttime operations.

Multiple cameras (e.g., time-of-flight (TOF), color (e.g., RGB or other color formats), monochrome cameras) and illumination sources (such as IR light sources) can be deployed in-cabin but the different illumination sources can impact a color reproduction of the color cameras. Other impacts caused by such illumination sources include: flicker, high noise, and failure to detect depth information for time-of-flight cameras.

### SUMMARY

One way to reduce illumination source interference is to use a different wavelength of illumination for a different subsystem. For example, a 940 nm wavelength light source can be used for DMS while a 850 nm wavelength light source can be used for time-of-flight (TOF) cameras. Another way is to use light filters to filter signals of a certain wavelength but light filters can be very costly.

Embodiments of the present application disclose an in-cabin monitoring system. The system can sync different cameras and illumination sources for monitoring (such as video conferencing, selfies, face identification) and/or gesture detection purposes for a vehicle. For one embodiment, a same illumination source can be used for different sensors, that is to say, a 940 nm wavelength illumination source can be used for both DMS and TOF cameras. In this case, the number of illumination sources can be reduced to one. For one embodiment, a system includes a sensor module, the sensor module includes at least a first and a second set of image sensors (e.g., cameras). The system includes a first illumination source. The system includes a signal generator to generate a sync signal, where the sync signal is to at least synchronize the first illumination source to the first set of image sensors such that objects illuminated by the first illumination source is not captured by the second set of image sensors while allowing the first set of image sensors to capture objects illuminated by the first illumination source. For one embodiment, one or more captured images are fused together.

### BRIEF DESCRIPTION OF THE DRAWINGS

The appended drawings illustrate examples and, therefore, are exemplary embodiments, and not to be considered limiting in scope.

FIG. 1 is a block diagram of an exemplary system architecture for a motor vehicle and a security server;

FIG. 2 is block diagram of one embodiment of an in-cabin monitoring system;

FIG. 3 is block diagram of one embodiment of an in-cabin monitoring system;

FIG. 4 is a block diagram of one embodiment of a sensor panel;

FIGS. 5A-5C are block diagrams of some embodiments of a signal graph;

FIG. 6A is an embodiment of a signal graph;

FIG. 6B is a chart corresponding to FIG. 6A for synchronizing signals/sensors according to one embodiment;

FIG. 7 is a block diagram of one embodiment for sensor images fusion;

FIG. 8 is a block diagram of one embodiment to generate a depth map;

FIG. 9 is a block diagram of one embodiment for 3D images fusion; and

FIG. 10 is a flow diagram of one embodiment of a method.

### DETAILED DESCRIPTION

A vehicle in-cabin monitoring system is disclosed in detail below. The monitoring system can monitor a status (such as video conferencing, selfies, face identification) of the driver/passengers in the cabin of a vehicle and/or used for a gesture-based control system. For example, the monitoring system can capture a gesture of a driver/passenger to control an entertainment system, driver assistance control system, air flow control system, etc., of a vehicle. The monitoring system can sync different cameras and illumination sources for the monitoring and/or gesture detection purposes for the vehicle. For one embodiment, an illumination source can be used for different sensors, that is to say, a single (e.g., 940 nm) illumination source can be used for both DMS and TOF cameras.

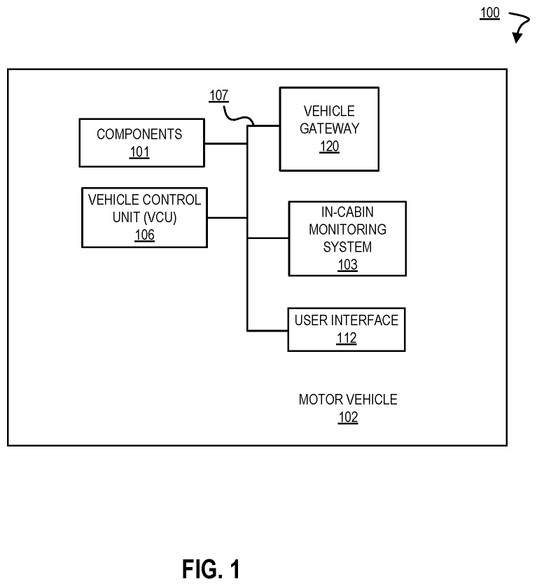

FIG. 1 is a block diagram for an example of a system architecture 100 for a motor vehicle. For some embodiments, motor vehicle 102 may be a fully electric vehicle, a partially electric (i.e., hybrid) vehicle, or a non-electric vehicle (i.e., vehicle with a traditional internal combustion engine) having an in-cabin monitoring system 103. Furthermore, although described mostly in the context of automobiles, including sport utility vehicles (SUV), the illustrated systems and/or methods can be used in other wheeled vehicles with cabin(s), such as trucks, buses, trains, etc. It can also be used in non-wheeled vehicles such as ships and airplanes. In fact, the illustrated embodiments can be used in any situation in which it is useful to integrate one or more cameras and/or illumination sources (e.g., IR light source) within an enclosed environment.

For one embodiment, motor vehicle 102 includes components 101, in-cabin monitoring system 103, vehicle control unit (VCU) 106, user interface 112, and vehicle gateway 120. In-cabin monitoring system 103 can provider one or more image sensors/illumination sources to capture images within a cabin of motor vehicle 102. In-cabin monitoring system 103 can be communicatively coupled to components 101, VCU 106, user interface 112, and/or vehicle gateway 120 via communications network 107.

Vehicle control unit (VCU) 106 can be a controller that includes a microprocessor, memory, storage, and a communication interface with which it can communicate with various systems such as components 101 and vehicle gateway 120 via network 107. Components 101 may be generally components of the motor vehicle 102. For example, components 101 can include adjustable seat actuators, power inverters, window controls, electronic braking systems, etc.

For one embodiment VCU 106 is the vehicle's main computer, but in other embodiments it can be a component separate from the vehicle's main or primary computer. For one embodiment, in-cabin monitoring system 103 and VCU 106 may be an integrated component.

Communications network 107 may be a controller area network (CAN) bus, an Ethernet network, a wireless communications network, another type of communications network, or a combination of different communication networks.

For some embodiments, vehicle gateway 120 is a gateway to external communications and vehicle gateway 120 may be hardened to implement one or more physical and logical barriers to prevent external systems from accessing vehicle network 107 without authorization.

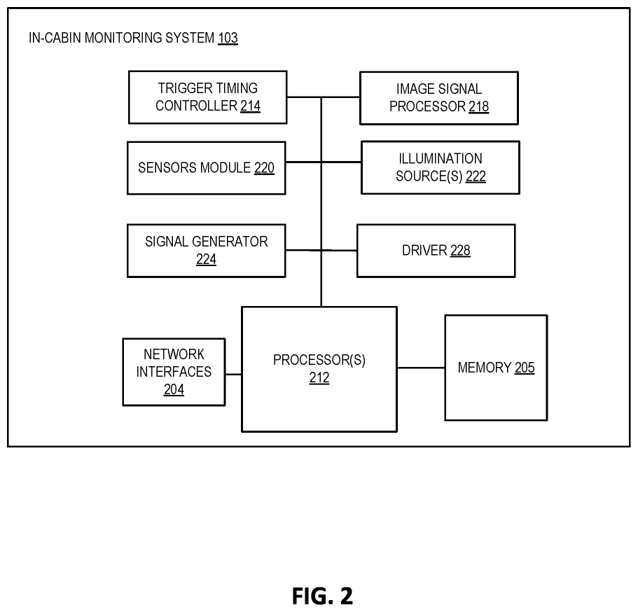

FIG. 2 is block diagram of an example of an in-cabin monitoring system according to one embodiment. Referring to FIG. 2, for one embodiment, in-cabin monitoring system 103 includes one or more processor(s) 212, memory 205, and network interfaces 204. Network interfaces 204 may communicatively couple motor vehicle 102 to any number of wireless subsystems (e.g., Bluetooth, WiFi, Cellular, or other networks), internal motor vehicle communication networks (e.g., a CAN bus, an Ethernet network, a wireless network, etc.) to transmit and receive data streams through one or more communication links.

Memory 205 may be coupled to processor(s) 212 to store instructions for execution by processor(s) 212. For some embodiments, memory 205 is non-transitory, and may store one or more processing modules of vehicle gateway 120. In-cabin monitoring system 103 can monitor a passenger/driver for safety purposes or for information for a gesture input that can replace one or more user inputs to user interface 112 of FIG. 1. In-cabin monitoring system 103 can include trigger timing controller 214, image signal processor(s) (ISPs) 218, sensors module 220, illumination source(s) 222, signal generator 224, driver 228. Controller 214 can control or manage an operation of sensor/illumination source triggers. ISP(s) 218 can be a specialized digital signal processor used for image processing. ISP(s) 218 can receive a frame (or image or picture) from any one sensor for image for processing. Sensors module 220 can include one or more sets of sensors to capture monochrome, red-green-blue (color), time-of-flight (TOF) images/pictures/frames. Illumination source(s) 222 includes any illumination sources such as infrared or non-infrared illumination sources. The illumination sources can be implemented using laser diodes, light emitting diodes (LED), etc. Signal generator 224 can generate a sync signal with two or more signal regions to sync the operations of illumination source(s) 222 and/or any sensors of sensors module 220. Driver 228 can driver a signal to trigger the operations (turn on/off) of the illumination source(s) 222 and/or any sensors of sensors module 220. In one embodiment, controller 212 can control or can be integrated with timing controller 214 and/or ISP(s) 218.

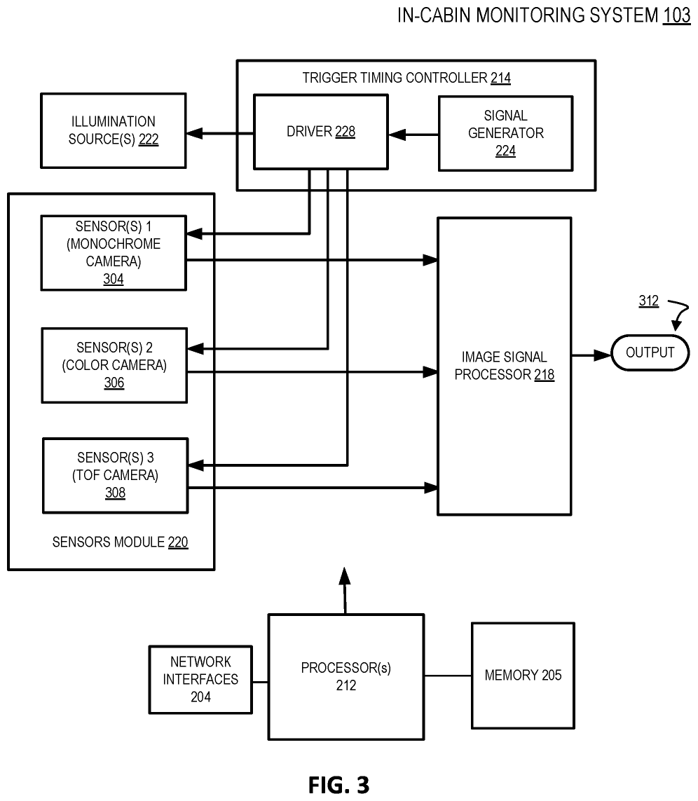

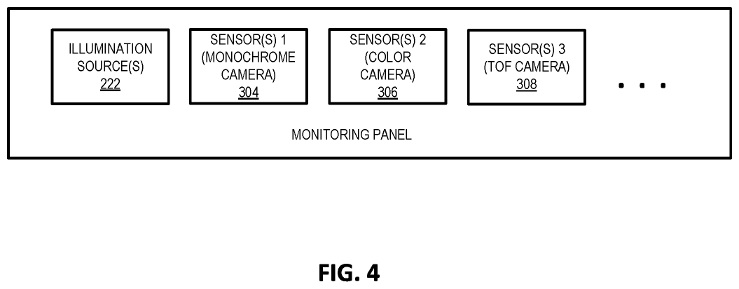

FIG. 3 is a block diagram of an example of an in-cabin monitoring system according to one embodiment. Referring to FIG. 3, for one embodiment, sensor module 220 of system 103 includes two or more sensors 304-308: monochrome camera(s) 304, RGB (color) camera(s) 306, and TOF camera(s) 308. Although three sensors are shown, system 103 can include two, three, or any number of more sensors. The sensors can be part of a driver monitoring system (DMS) adapted to function with other cameras/illumination sources or standalone sensor/illumination source units. For one embodiment, sensor module 220 and illumination source 222 are mounted on a monitoring panel near a vehicle dashboard, in front of driver/passengers. FIG. 4 illustrates an example embodiment of such a monitoring panel.

For one embodiment, TOF cameras 308 can include a TOF camera embedded at a ceiling (upper) portion of a cabin of a vehicle to detect a top-down view of hand movements of passengers for gesture-based control inputs. Note here, a TOF camera is a camera that uses an artificial IR light source (light in a frequency spectrum that is invisible to human eyes but detectable by cameras) to determine depth information. For example, an artificial IR light source (e.g., illumination source 222) emits a light signal, which hits an object and the light signal is reflected to return to a camera sensor. The time it takes the light signal to bounce back (e.g., time of flight) is then measured to determine depth information. Thus, a scene (depth map) can be measured with one or more artificial light pulse(s). Color and monochrome cameras typically include silicon imaging sensors in the 400-1100 nm wavelengths, e.g., wavelengths that overlap portions of the IR wavelengths. Monochrome sensors have no color filters while color sensors typically have three (red, green, and blue) color filters. Thus, a monochrome sensor can capture more spatial information for a given sensor profile similar to a color sensor. For one embodiment, the capture rate (or frame per second, fps) for each of the sensors are different. For example, the color sensor can be rated at 30 fps, monochrome—45 fps, and TOF—50 fps. Although only three types of sensors are disclosed, the vehicle cabin can include any number of types of sensors.

Referring to FIG. 3, for one embodiment, controller 214 can sync at least four components, illumination sources 222, TOF sensors, color sensors, and monochrome sensors to be on at a certain portion of time. Note that illumination sources 222 can include any type of illumination sources such as IR LEDs or laser IR sources. IR laser sources have a narrowband spectrum, while IR LEDs has a very broadband spectrum. Because IR LEDs are broadband, for one embodiment, system 103 can use a single IR broadband LED to serve all sensors. For one embodiment, the sensors can be categorized into two or more sets of sensors, e.g., a first set (e.g., TOF sensors) to be triggered (via driver 228) to capture objects illuminated by the illumination source (e.g., IR light source) and a second set (e.g., monochrome, color) to capture the objects when the illumination source is turned off so to eliminate interferences. For one embodiment, controller 214 is configured to cause a signal generator 224 to generate a sync signal with two or more signal regions, where a first region triggers to cause the illumination source and the first set of image sensors to be on and the second set of image sensors to be off or the second set of image sensors to remain off, and a second region triggers to cause the second set of image sensors to be on and the first set of image sensors and the illumination source to be off or while the first set of image sensors and the illumination source remain off. For one embodiment, the signal regions contains two or more pulses for triggering and only a portion of the pulses (e.g, 4 pulses of total 5 pulses) triggers a subset of illumination source/sensors to be on, thus, reducing a power consumption and ambient noise captured by the sensors. Thus, because illumination sources/sensors are on only when they are required, interference can be reduced and sensor filters are not required.

For another embodiment, the sync signal can include three or more signal regions, where a third region triggers to cause a second illumination source and a third set of image sensors to be on (e.g., the second illumination source synced to the third set of image sensors). Although only three signal regions are disclosed, any number of signal regions can be used to isolate and/or sync one or more illumination sources to a number of sensors.

Once the sensors and illumination sources are synced, the output frames (or images) of the sensors can be received by image signal processor(s) 218. Image signal processor(s) 218, for one embodiment, fuses the monochrome and color frames together to improve a spatial resolution and dynamic range of the color frames leading to better low light performance and an improved signal-to-noise ratio (SNR) of the color sensor(s). Image fusion (as described below) is the process of combining two or more images into a single frame (e.g., image). The main reason for combining the images is to get a more informative output image.

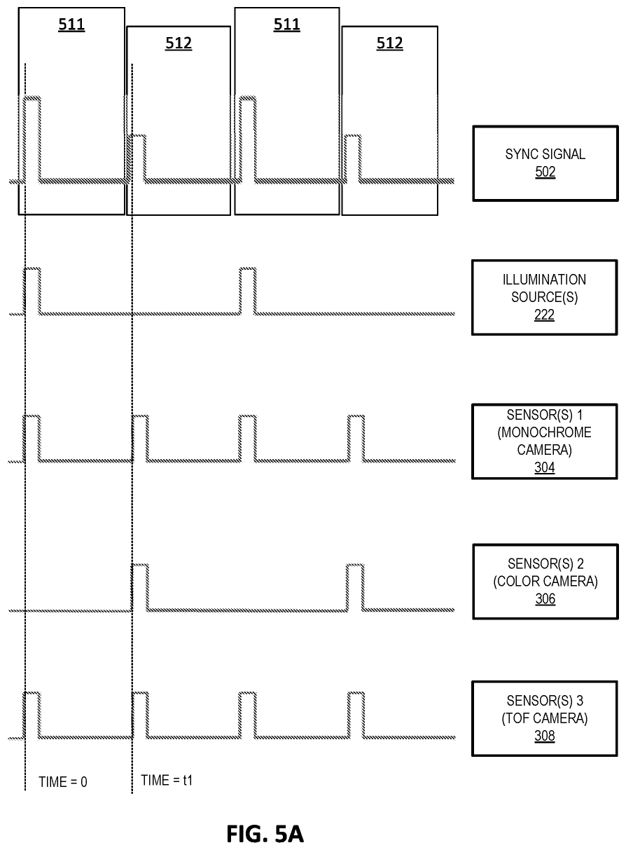

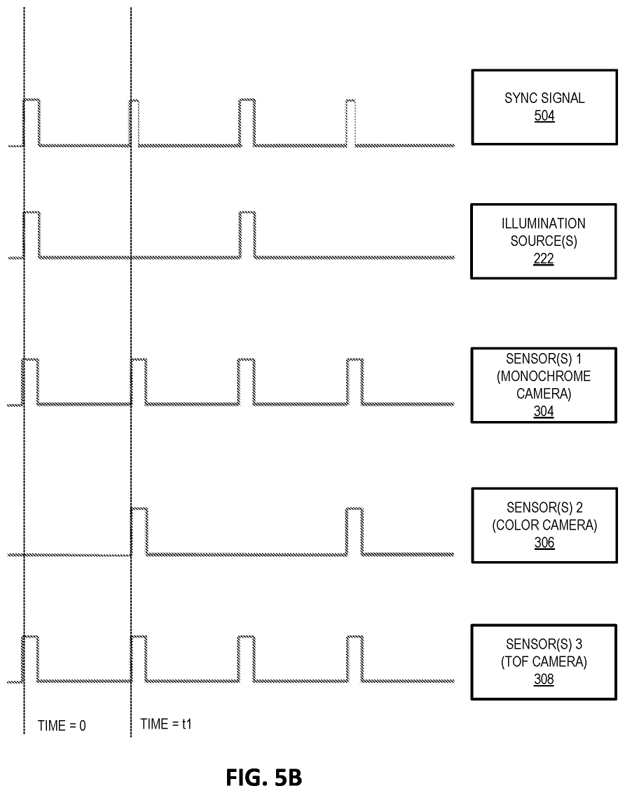

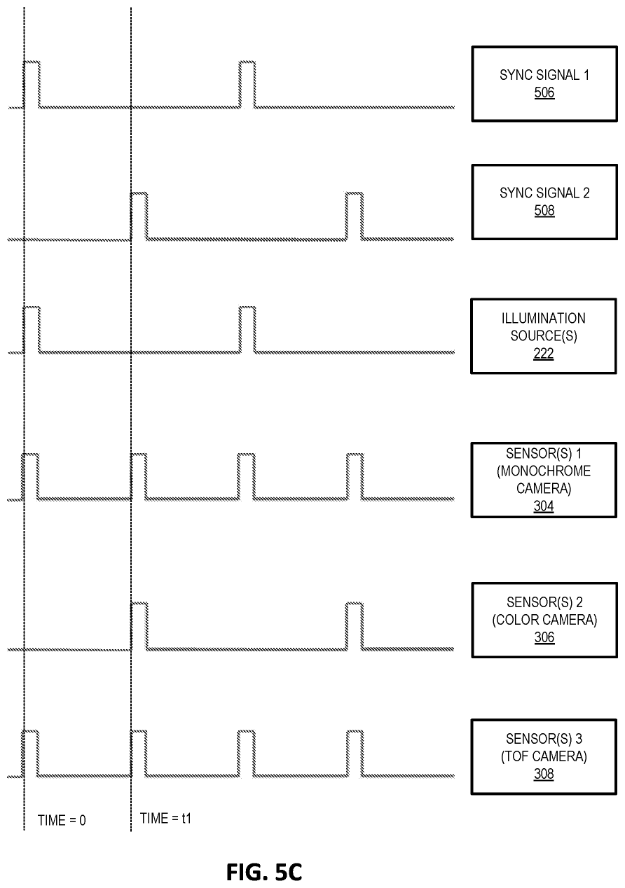

FIGS. 5A-5C are block diagrams of some embodiments of a signal graph. Referring to FIG. 5A, for one embodiment, sync signal 502 includes two signal regions 511-512. Here, a first region 511 pulses with a high voltage amplitude and a second region 512 pulses with a lower voltage amplitude. Although triggering by amplitude is shown for ease of illustration, other triggering mechanisms can be used, such as, triggering based on a pulse width, a rising edge or a falling edge of a sync signal; and triggering by two or more separate sync signals, individually or in combination, etc., as indications for the signal regions.

Referring to FIG. 5A, at time=0, sync signal 502 triggers a first signal region, and the first signal region is to cause the illumination source and a first set of sensors (e.g., sensors 1 & 3) to be on for a predetermined pulse duration. In this case, monochrome camera 304 and TOF camera 308 is on. At time=t1, sync signal 502 triggers a second signal region, and the second signal region is to cause the second set of sensors (e.g., sensor 2) to be on for a predetermined pulse duration, in this case, color camera 306 is on. Thus, in this example, using two or more signal regions, the color camera can be separated from the illumination source to reduce an interference of signal received by the color camera.

Referring to FIG. 5B, for one embodiment, sync signal 504 includes two signal regions. The signal regions are triggers by two separate pulse widths of sync signal. Although two pulse widths are shown, any number of pulse widths triggering illumination sources/sensors can be implemented. Referring to FIG. 5C, for one embodiment, two sync signals 506-508 are used to trigger two signal regions, respectively, e.g., one signal for each region. For another embodiment, sync signals 506-508, in combination, can trigger two or more signal regions.

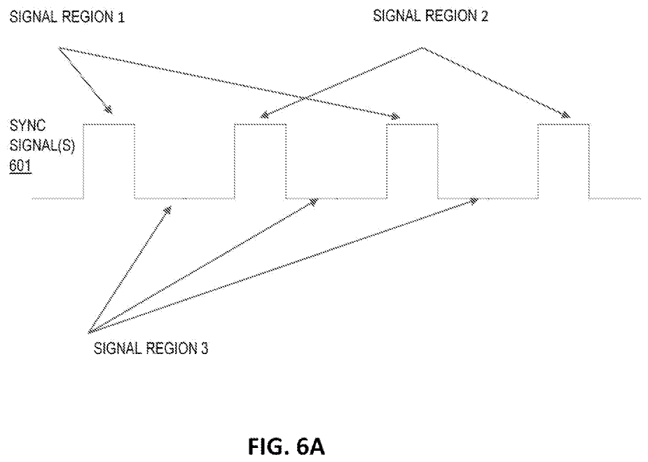

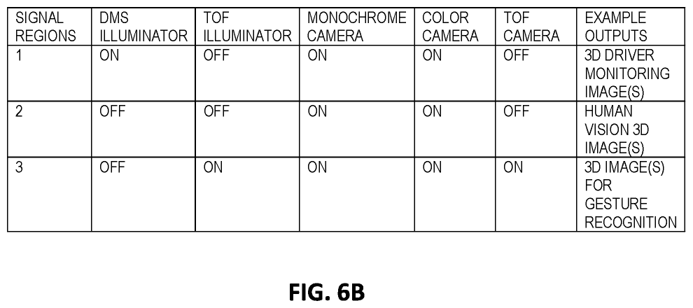

FIG. 6A is an embodiment of a signal graph and FIG. 6B is a chart corresponding to FIG. 6A for synchronizing signals/sensors according to one embodiment. Referring to FIGS. 6A-6B, sync signal(s) 601 can include three signal regions (signal regions 1-3) to be used to sync a number of illuminators and/or sensors. Each of the signal regions can generate a set of output for a particular purpose. For example, for signal region 1, driver monitoring system (DMS) illuminator, monochrome and color cameras are on, while ToF illuminator and ToF camera remain off. The example output for signal region 1 can be driver monitoring image(s). In one embodiment, the output images for signal region 1 are combined together to generate a 3D driver monitoring image (e.g., a depth map).

For signal region 2, the monochrome and color cameras may be on, while the DMS illuminator, ToF illuminator, and ToF camera remain off. The example output for signal region 2 can be human vision image(s). In one embodiment, the output images for signal region 2 are combined to generate 3D human vision image(s).

For signal region 3, the ToF illuminator, monochrome and color cameras are on, while DMS illuminator remains off. The example output for signal region 3 is ToF image(s) for gesture recognition for passengers/driver of the vehicle.

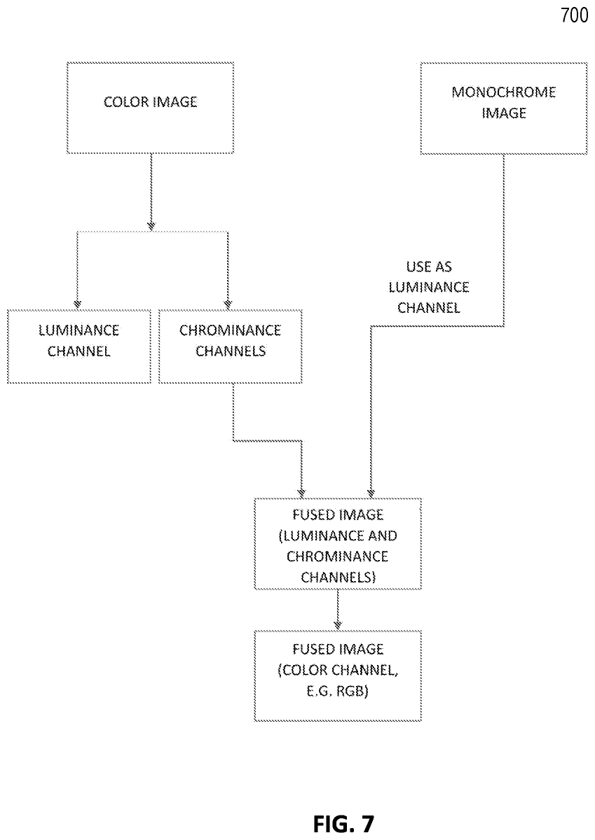

FIG. 7 is a block diagram of one embodiment for sensor images fusion. The images fusion process 700 can be performed by an image signal processor, such as processor 218 of FIG. 3. In one embodiment, process 700 can be applied for a particular signal region, such as signal region 2 of FIGS. 6A-6B. Referring to FIG. 7, a color image (a RGB or any other color formats such as YCbCr) captured by a color camera sensor and a monochrome (gray) image captured by a monochrome camera sensor having overlapping or non-overlapping field of views can be fused together. Fusing the two images together allows the system to obtain more information for objects captured in the images. For example, a monochrome sensor typically has a higher quantum efficiency than an color sensor and can thus reach a higher signal-to-noise ratio (SNR). In addition, a monochrome sensor can provide higher resolution due to higher spatial frequency compare to that of a color sensor with color filters (e.g. Bayer pattern color filters). The color image can be converted into luminance and chrominance channels by converting to a YCbCr format, where Y is the luminance channel, and Cb and Cr are the Chrominance channels. Next, the chrominance channels of the color image, can be added to the monochrome image of the luminance channel to obtain a fused image in luminance and chrominance channels. The fused image can be then converted to a color image of any other color format (e.g. RGB image). For the foregoing image fusion, since the monochrome sensor is more sensitive to light compare to a color sensor, we can apply a lower gain to monochrome sensor and a higher gain to the color sensor to achieve a higher dynamic range in the fused image. The fused image can thus provide a better resolution, a higher dynamic range, leading to a monitoring system having a better low light performance and an improved signal-to-noise ratio (SNR). For another embodiment, a plurality of color and/or monochrome images having different field of views (FOVs) (e.g., images captured by cameras of wide, telescopic, and/or narrow views, etc.) can be fused together to provide an “optical zoom”. In this case, the images with a higher resolution replaces images with portions (for overlapping field of views) having a lower resolution, thus leading to improvements in resolution. For example, a camera to monitor a driver usually has a narrow FOV while a camera to monitor passenger activities usually has a broader FOV. Fusing these two cameras images together provides the system with an improved resolution for the FOV of the driver monitoring areas while retaining the broader FOV. For another example, images with overlapping or non-overlapping FOV can be stitched together as part of image fusion.

In one embodiment, the image fusion process can be performed by an image signal processor, such as processor 218 of FIG. 3. The image fusion process can include a linear process which includes pre-processing. fusion, and post-processing operations. The pre-processing operations include applying an algorithm to the input images to be fused to correct the images for distortion, scale, shift, imperfections that may be introduced by the respective cameras/lens of the cameras. For this process, the system may include a calibration table for each camera that applies a number of operations to the images for image corrections. The calibration table may be determined at the time when the respective camera is calibrated.

The fusion operations may apply an image recognition algorithm, or a machine learning algorithm to the images being fused. This process may apply a different algorithm based on the type of fusion or being performed. Fusion two or more images having a similar field of view can include aligning the pixels for overlapping features between the images and blending these pixels together for an output image. In one embodiment, any two images can be fused together by calculating a fundamental or essential matrix for the two images and mapping points in the one image to another by searching best matching points along epipolar scanlines using the fundamental and/or essential matrix. An essential matrix contains information about translation and rotation which describes the location of the second camera relative to the first camera in global coordinates. A fundamental matrix contains the information of the essential matrix and intrinsic calibration information of both cameras which relates two images of the same scene that constrains where projection of points from the scene can occur in both images, e.g., along an epipolar scanline.

For an example implementation in openCV, a system can use scale-invariant feature transform (SIFT) or Laplacian of Gaussian to find a predetermined number of keypoints and descriptors for both images. The system then applies a feature approximate nearest neighbor search (FLANN)-based matching (or any other type of feature matching algorithm) to match the keypoints and/or descriptors between the two images. Based on the matching, a fundamental matrix can be calculated for the two images. The system then fuses the images together by searching for best matching points along epipolar scanlines of one image based on corresponding points of another image using the fundamental matrix followed by combining the luminance and chrominance channels of the two images for a fused image.

After the images are fused, a post-processing operation can be applied to the fused image where the post-processing operation include operations to identify and remove artifacts that may be introduced into the fused image or converting the image from one color format to another (e.g., YCbCr to RGB).

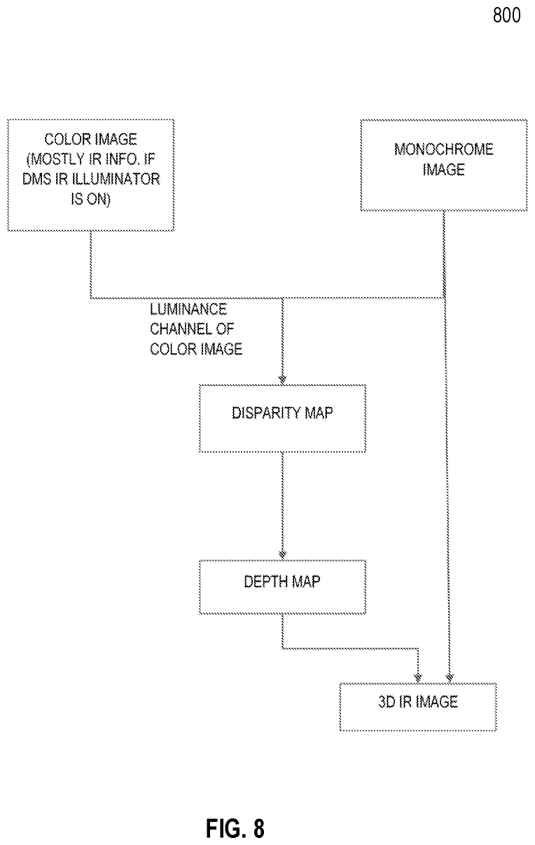

FIG. 8 is a block diagram of one embodiment to generate a depth map. The depth map generation process 800 can be performed by an image signal processor, such as processor 218 of FIG. 3. In one embodiment, process 800 can be applied for a particular signal region, such as signal region 1 of FIGS. 6A-6B. Referring to FIG. 8, a color image (a RGB or any other color formats such as YCbCr) captured by a color camera sensor and a monochrome (gray) image captured by a monochrome camera sensor having overlapping or non-overlapping field of views can be used to generate a depth map or a 3D infrared image. For one embodiment, a system generates a disparity map based on a luminance channel of the color image and the monochrome image. A depth map is generated based on the disparity map. The depth map is then fused with the monochrome image to generate a 3D infrared image.

For an example implementation, a depth (distance measurement) for a point in a scene of a stereo image can be estimated by a stereo camera having an equivalent triangle setup based on the equation: depth=baseline*focal/disparity, where baseline is a distance between two cameras, focal is a focal length of the camera, and disparity is a length difference between any two corresponding pixel points in the two images. An implementation in openCV can generate a disparity map (e.g., the disparity) using the createStereoBM subroutine. Based on the disparity map, and known values for focal lengths and baseline of the two cameras setup, a 3D depth (IR) image can be generated.

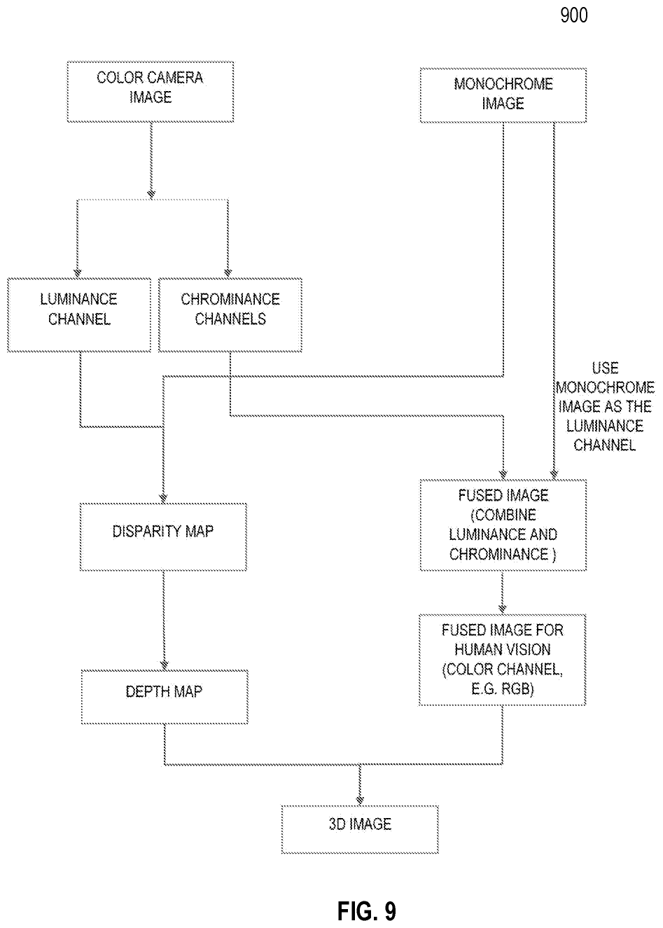

FIG. 9 is a block diagram of one embodiment for 3D images fusion. Process 900 can be performed by an image signal processor, such as processor 218 of FIG. 3. In one embodiment, process 900 can be applied for one or more signal regions, such as signal regions 1 and 2 of FIGS. 6A-6B. For example, the depth map can be generated based on a process similar to process 800 of FIG. 8 and the fused image for human vision can be generated based on a process similar to process 700 of FIG. 7. The depth map and the fused image can then be combined to generate a 3D color image.

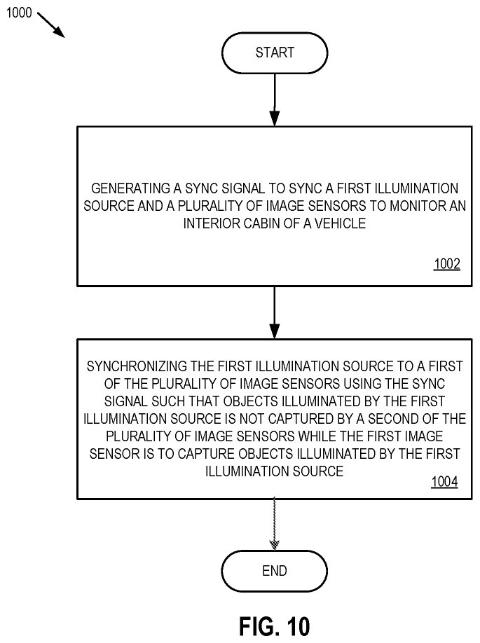

FIG. 10 is a flow diagram of one embodiment of a method. Method 1000 can be performed by processing logic that may comprise hardware (circuitry, dedicated logic, etc.), software (such as is run on a general purpose computer system or a dedicated machine), firmware, or a combination. For one embodiment, method 1000 is performed by an in-cabin monitoring system (e.g., in-cabin monitoring system 103 of FIG. 1) of a vehicle.

Referring to FIG. 10, at processing block 1002, processing logic generates a sync signal to sync a first infrared (IR) light source and a plurality of image sensors to monitor an interior cabin of a vehicle.

At processing block 1004, processing logic synchronizes a first IR light source to a first and a second of the plurality of image sensors using the sync signal such that objects illuminated by the first light source is not captured by the second image sensor while the first image sensor is to capture objects illuminated by the first light source.

For one embodiment, the sync signal includes a plurality of signal regions, where for a first of the plurality of signal regions, processing logic triggers, using the sync signal, to cause the first light source and the first image sensor to be on and the second image sensor to be off. For a second of the plurality of signal regions, processing logic triggers, using the sync signal, to cause the second image sensor to be on and the first image sensor and the first light source to be off. For one embodiment, the first image sensor includes a time of flight (TOF) camera mounted on an upper portion of the vehicle cabin.

For one embodiment, the second image sensor includes a color camera. For one embodiment, the color camera includes a silicon imaging sensor which can detect a range of wavelength approximately 400-1100 nm.

For one embodiment, processing logic further fuses a color (e.g., RGB) image captured by the color camera and an image captured by the monochrome camera to increase a dynamic range of the color (e.g., RGB) image. For one embodiment, the first image sensor captures at a different frames per second (or points in time) than the second image sensor.

For one embodiment, the first light source is an IR light emitting diode source. For one embodiment, for a third of the plurality of signal regions, processing logic triggers, using the sync signal, to cause the second light source to be synced to a third of the plurality of image sensors. For one embodiment, the first light source, and the first and second image sensors are pulsed simultaneously to reduce an ambient noise captured by the first and second image sensors.

The embodiments as will be hereinafter described may be implemented through the execution of instructions, for example as stored in memory or other element, by processor(s) and/or other circuity of motor vehicle 102. Particularly, circuitry of motor vehicle 102, including but not limited to processor(s) 212 may operate under the control of a program, routine, or the execution of instructions to execute methods or processes in accordance with the aspects and features described herein. For example, such a program may be implemented in firmware or software (e.g. stored in memory 205) and may be implemented by processors, such as processor(s) 212, and/or other circuitry. Further, the terms processor, microprocessor, circuitry, controller, etc., may refer to any type of logic or circuitry capable of executing logic, commands, instructions, software, firmware, functionality and the like.

Further, some or all of the functions, engines, or modules described herein may be performed by motor vehicle 102 itself and/or some or all of the functions, engines or modules described herein may be performed by another system connected through network interface 204 to motor vehicle 102. Thus, some and/or all of the functions may be performed by another system, and the results or intermediate calculations may be transferred back to motor vehicle 102.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in various ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

For one or more exemplary embodiments, the functions described may be implemented in hardware, software, firmware, or any combination thereof. If implemented in software as a computer program product, the functions may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments is provided to enable one to make or use the methods, systems, and apparatus of the present disclosure. Various modifications to these embodiments will be readily apparent, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. An monitoring system of a vehicle, the monitoring system comprising:
a sensor module, the sensor module comprising a plurality of image sensors;
a first illumination source; and
a signal generator to generate a sync signal, wherein the sync signal is to at least synchronize the first illumination source to a first of the plurality of image sensors such that objects illuminated by the first illumination source is not captured by a second of the plurality of image sensor while allowing the first image sensor to capture objects illuminated by the first illumination source.

2. The monitoring system of claim 1, wherein the sync signal includes a plurality of signal regions, wherein
for a first of the plurality of signal regions, the sync signal triggers to cause the first illumination source and the first image sensor to be on and the second image sensor to be off; and
for a second of the plurality of signal regions, the sync signal triggers to cause the second image sensor to be on and the first image sensor and the first illumination source to be off.

3. The monitoring system of claim 1, wherein the first image sensor include a time of flight (TOF) camera mounted on a upper portion of the vehicle cabin.

4. The monitoring system of claim 3, wherein the second image sensor include a color camera.

5. The monitoring system of claim 4, wherein the color camera includes a silicon imaging sensor in a range of wavelength approximately 400-1100 nm.

6. The monitoring system of claim 4, further comprising fusing a color image captured by the color camera and an image captured by a monochrome camera to increase a dynamic range of the color image.

7. The monitoring system of claim 1, wherein the first image sensor captures at a different points in time than the second image sensor.

8. The monitoring system of claim 1, wherein the first illumination source is an infrared illumination emitting diode source.

9. The monitoring system of claim 1, further comprising a second illumination source; and wherein for a third of the plurality of signal regions, the sync signal is to cause the second illumination source to be synced to a third of the plurality of image sensors.

10. The monitoring system of claim 1, wherein the first illumination source, the first and second image sensors are pulsed to reduce an ambient noise captured by the first and second image sensors.

11. A method to sync a plurality of image sensors, the method comprising:
generating a sync signal to sync a first illumination source to a plurality of image sensors to monitor an interior cabin of a vehicle; and
synchronizing the first illumination source to a first of the plurality of image sensors using the sync signal such that objects illuminated by the first illumination source is not captured by a second of the plurality of image sensors while the first image sensor is to capture objects illuminated by the first illumination source.

12. The method of claim 11, wherein the sync signal includes a plurality of signal regions, wherein
for a first of the plurality of signal regions, triggering by the sync signal to cause the first illumination source and the first image sensor to be on and the second image sensor to be off; and
for a second of the plurality of signal regions, triggering by the sync signal to cause the second image sensor to be on and the first image sensor and the first illumination source to be off.

13. The method of claim 11, wherein the first image sensor includes a time of flight (TOF) camera mounted on a upper portion of the vehicle cabin.

14. The method of claim 13, wherein the second image sensor includes a color camera.

15. The method of claim 14, wherein the color camera includes a silicon imaging sensor in a range of wavelength approximately 400-1100 nm.

16. The method of claim 14, further comprising fusing a color image captured by the color camera and an image captured by a monochrome camera to increase a dynamic range of the color image.

17. The method of claim 11, wherein the first image sensor captures at a different points in time than the second image sensor.

18. The method of claim 11, wherein the first illumination source is an infrared illumination emitting diode source.

19. The method of claim 11, further comprising for a third of the plurality of signal regions, triggering by the sync signal to cause a second illumination source to be synced to a third of the plurality of image sensors.

20. The method of claim 11, wherein the first illumination source, the first and second image sensors are pulsed to reduce an ambient noise captured by the first and second image sensors.
